(19) United States
(12) Patent Application Publication
(10) Pub. No.: US 2013/0185453 A1
(43) Pub. Date: Jul. 18, 2013

(54) SYSTEM, METHOD AND APPARATUS FOR PROVIDING MULTIMEDIA SOCIAL STREAMING

(71) Applicant: Rick Steven Louie, Los Gatos, CA (US)

(72) Inventor: Rick Steven Louie, Los Gatos, CA (US)

(21) Appl. No.: 13/436,036

(22) Filed: Mar. 30, 2012

Related U.S. Application Data
(60) Provisional application No. 61/586,243, filed on Jan. 13, 2012.

(51) Int. Cl. G06F 15/16

(52) U.S. Cl. 709/231

(57) ABSTRACT

The present invention generally relates to social media streaming. In particular, embodiments of the invention relate to an apparatus and a method for providing streaming of one or more forms of content across one or more networks. In a preferred embodiment, the apparatus is a wearable device comprising a computing device configured to process and transmit one or more forms of content (e.g., audio, video) to one or more remote social networks.

### FIELD OF THE INVENTION

The present invention generally relates to social media streaming. In particular, embodiments of the invention relate to an apparatus and a method for providing streaming of one or more forms of content across one or more networks. In a preferred embodiment, the apparatus is a wearable device comprising a computing device configured to process and transmit one or more forms of content (e.g., audio, video) to one or more remote social networks.

### BACKGROUND

In the past several years, social networking has become ubiquitous. Internet users have taken to following their favorite individuals on a multitude of fan based, peer based or other interest group relational matching social networks, such as Twitter, Facebook, Tumblr, Foursquare and Pinterest. On these sites, users are typically provided the ability to receive constant streams of updates related to one or more people or groups that match one or more of the user's interests.

While current social networks and other social media systems allow users to post pictures and short text messages nearly instantaneously, their usefulness typically ends there. Furthermore, in order for users to interact with these social networks and other social media systems, users need to actively engage with a computing device, such as a smartphone or tablet pc. These actions require direct input and interaction, making random events hard to capture in the moment, requiring a user to go back and recount the occurrence. This is especially difficult if the content of the event is of limited duration (e.g., audio, imagery, video). If a user does not capture the event when it occurs, they are limited to recounting it in alternate means later (e.g., describing the event in text).

Another drawback of the current art is that all the devices currently configured to interact with these networks are typically stowed during normal activities, requiring the user to retrieve the device prior to utilizing the device to capture and record a desired event. For instance, smartphones must be retrieved from a pocket, purse or holster and tablet PCs must be retrieved from a case, backpack, purse or other transport means.

Yet another drawback is that the devices currently used to interact with social networks and other social media systems is that they potentially require the user to monitor them during use and they can be interrupted by other operations (e.g., incoming phone calls, e-mails, SMS messages).

Finally, current social networks and other social media systems only allow for specific units of data to be shared at one time. For instance, Twitter only allows 140 characters in a single message, Facebook wall post are static blocks of text and/or images, blog posts are much like a news article or other short written work, potentially with pictures. No social network or other social media system provides users the ability to stream live content to its users as it happens.

Therefore, there is need in the art for an apparatus and a method for providing streaming of one or more forms of content across one or more networks without requiring significant interaction from a user. These and other features and advantages of the present invention will be explained and will become obvious to one skilled in the art through the summary of the invention that follows.

### SUMMARY OF THE INVENTION

Accordingly, it is an aspect of the present invention to provide apparatus and a method for providing streaming of one or more forms of content across one or more networks without requiring significant interaction from a user.

According to an embodiment of the present invention, An apparatus for providing multimedia social streaming is comprised of: a wearable housing comprising: a content recording means; a processing means; a communications means; and a power source, wherein said content recording means is configured to receive one or more forms of content data, wherein said processing means is configured to process said content data into transmittable content format data, wherein said communications means is configured to transmit said transmittable content format data, and wherein said power source is configured to provide operable power to one or more of said content recording means, processing means and communications means.

According to an embodiment of the present invention, the wearable housing is an ornamental piece of jewelry.

According to an embodiment of the present invention, the one or more forms of content data include one or more of audio data or video data.

According to an embodiment of the present invention, the one or more forms of content data is comprised of live content.

According to an embodiment of the present invention, the wearable apparatus has a storage means, wherein said communications means is configured to transmit said transmittable content format data to said storage means and said storage means is configured to store said transmittable content format data.

According to an embodiment of the present invention, the wearable apparatus has one or more ports transposed through said wearable housing.

According to an embodiment of the present invention, at least one of said one or more ports is configured to allow said power source to be attached to a recharging means.

According to an embodiment of the present invention, at least one of said one or more ports is configured to allow said communications means to transmit said transmittable content format data to a computing device attached to said port.

According to an embodiment of the present invention, the transmittable content format data is transmitted to a remote social network configured to allow one or more users to stream and consume said transmittable content format data.

According to an embodiment of the present invention, a method for providing multimedia social streaming via a wearable apparatus includes the steps of: receiving one or more forms of content data at a content recording means of said wearable apparatus; processing said one or more forms of content data, at a processing means of said wearable apparatus, into transmittable content format data; and transmitting said transmittable content format data, via a communications means of said wearable apparatus, to a remote social network.

According to an embodiment of the present invention, the wearable apparatus is an ornamental piece of jewelry.

According to an embodiment of the present invention, the one or more forms of content data include one or more of audio data or video data.

According to an embodiment of the present invention, the one or more forms of content data comprises live content.

According to an embodiment of the present invention, the method described above further includes the steps of: receiving said transmittable content format data in a storage means of said wearable apparatus; and storing, in said storage means, said transmittable content.

According to an embodiment of the present invention, the method described above further includes the steps of: receiving said transmittable content format data at a computing device attached to a port of said wearable apparatus.

According to an embodiment of the present invention, the transmittable content format data is transmitted to a remote social network configured to allow one or more users to stream and consume said transmittable content format data.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 is a flowchart of an exemplary method in accordance with an embodiment of the present invention;

FIG. 4 is an illustration of a wearable apparatus in accordance with an embodiment of the present invention;

FIG. 5 is an illustration of a wearable apparatus in accordance with an embodiment of the present invention;

FIG. 6 is an illustration of a wearable apparatus in accordance with an embodiment of the present invention;

FIG. 7 is an illustration of a wearable apparatus in accordance with an embodiment of the present invention;

FIG. 8 is an illustration of a wearable apparatus in accordance with an embodiment of the present invention; and

FIG. 9 is an illustration of a wearable apparatus in accordance with an embodiment of the present invention.

### DETAILED SPECIFICATION

The present invention generally relates to social media streaming. In particular, embodiments of the invention relate to an apparatus and a method for providing streaming of one or more forms of content across one or more networks. In a preferred embodiment, the apparatus is a wearable device comprising a computing device configured to process and transmit one or more forms of content (e.g., audio, video) to one or more remote social networks.

According to an embodiment of the present invention, the apparatus is comprised of a computing device incorporated into a wearable device. Embodiments of the present invention may further utilize computing devices to process and receive information transmitted from or by the wearable device of the present invention. For instance, exemplary methods of the present invention, as described herein, may utilize one or more servers comprised of computing devices to provide additional processing and communication steps above and beyond those provided by the wearable device.

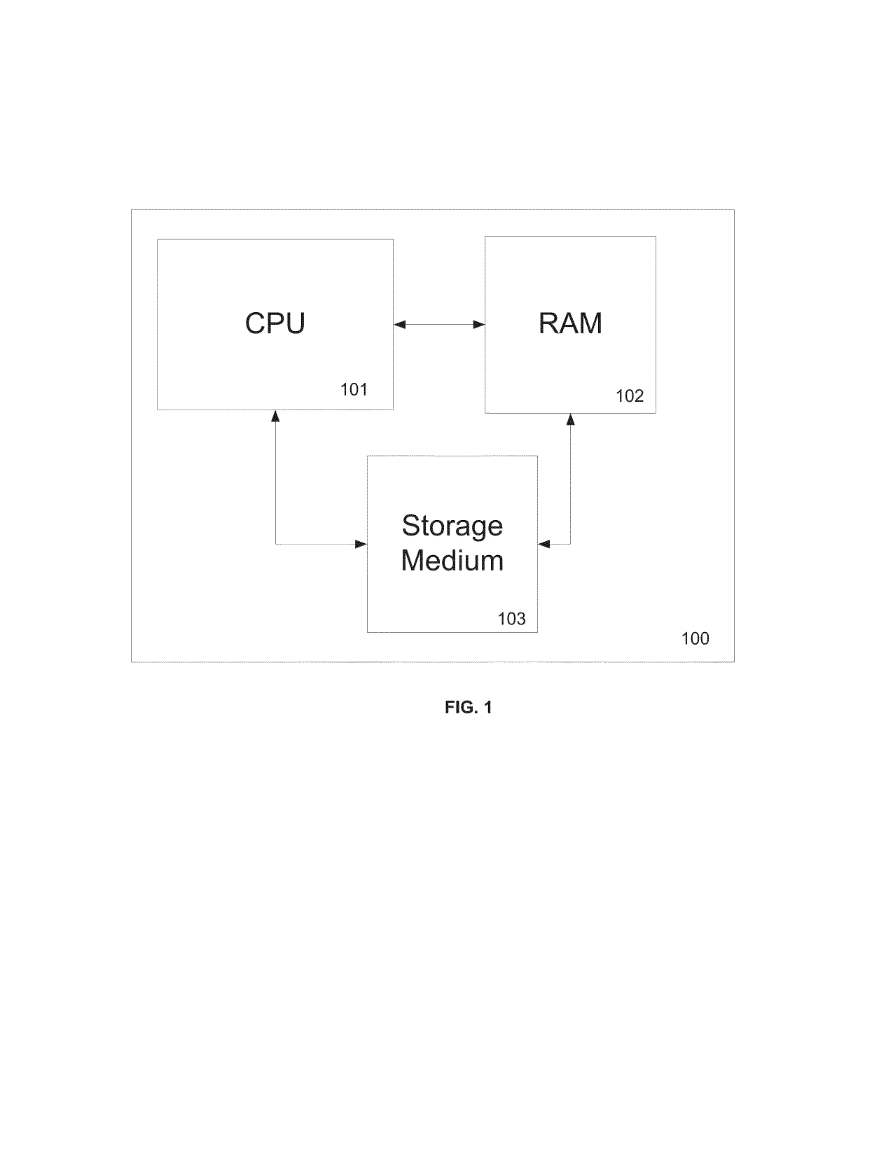

As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to/from the wearable device, stored by the wearable device and provided by the wearable device to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs to each other and/or to the wearable device. One of ordinary skill in the art would appreciate that there are numerous manners in which the system could be configured and embodiments of the present invention are contemplated for use with any configuration.

In general, the system and methods provided herein may be consumed by a user of the wearable device apparatus, as described herein, whether connected to a network or not. According to an embodiment of the present invention, some of the applications of the present invention may not be accessible when not connected to a network, however a user may be able to compose data offline that will be consumed by the system when the user is later connected to a network.

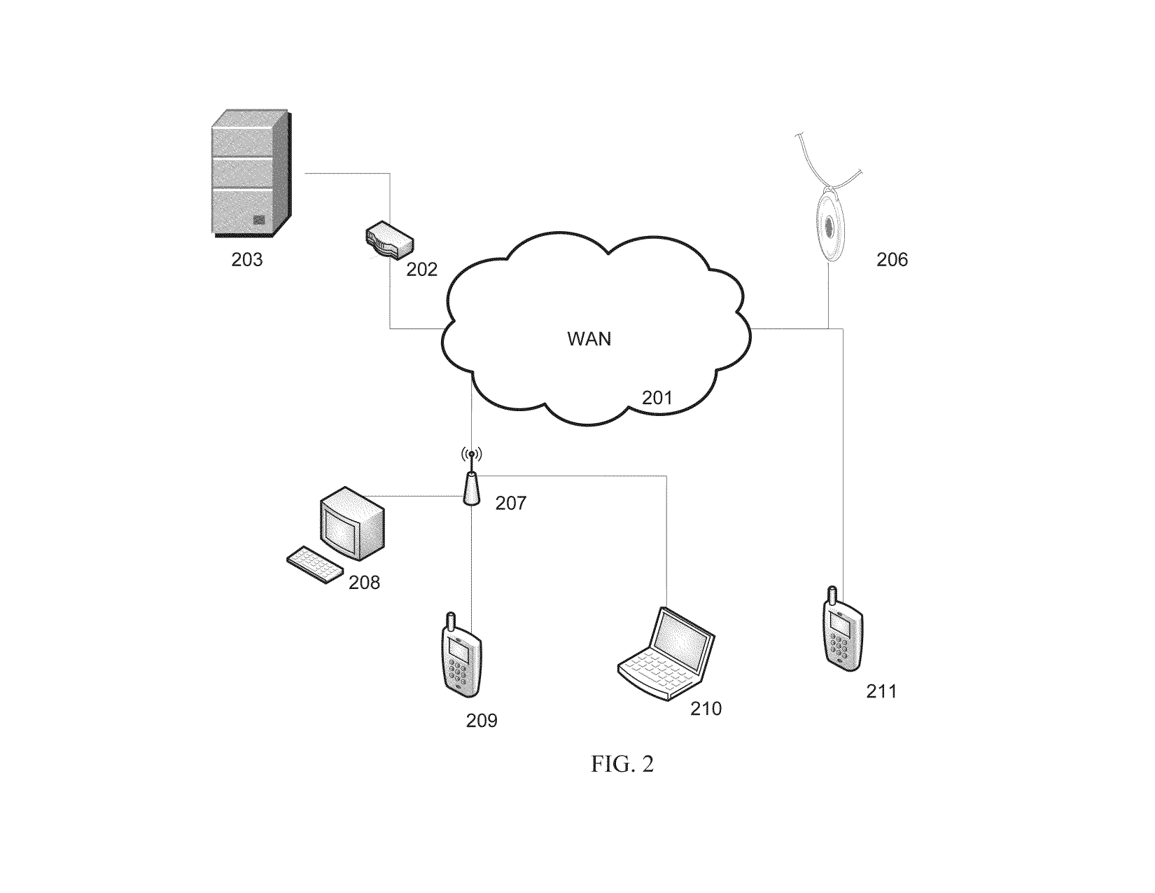

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a wearable device apparatus directly connected to the WAN (or via a wireless connection means such as CDMA, GSM, 3G, 4G) 206, ii) through a computing device 208, 209, 210 connected to a wireless access point 207 or iii) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

According to an embodiment of the present invention, an apparatus is provided that is configured to allow for the communication of content to one or more social networks or other social media systems (collectively social networking systems). In a preferred embodiment of the present invention, the apparatus is comprised of a wearable device (e.g., necklace, earrings, rings, watch, cufflink, glasses, sunglasses, hats, shirts, belt buckles, necktie, pendant, lapel pin, scarft, earmuffs). In this manner, users of the apparatus may be provided with a nonintrusive method for providing content to social networking systems.

According to an embodiment of the present invention, the apparatus is comprised of a wearable housing, a content recording means, a processing means, a communications means and a power source.

According to an embodiment of the present invention, the wearable housing is the portion of the apparatus that resembles and functions as an otherwise ordinary piece of jewelry or other wearable accessory/article that provides a user the ability to discretely wear the apparatus without providing any otherwise unwanted distraction. As noted above, the wearable housing could be, for instance, a necklace, an earring, a ring, a watch, a cufflink, a pair of glasses or a pair of sunglasses. One of ordinary skill in the art would appreciate that there are numerous types of wearable housings that could be utilized with embodiments of the present invention and embodiments of the present invention are contemplated for use with any type of wearable housing.

According to an embodiment of the present invention, the content recording means of the apparatus is configured to allow the recording of one or more types of content. Content includes, but is not limited to, audio content, video content or any combination thereof. Means for recording said content includes microphones, still image devices, video imaging devices or any combination thereof. One of ordinary skill in the art would appreciate that there are numerous types of content recording means that could be utilized with embodiments of the present invention and embodiments of the present invention are contemplated for use with any content recording means.

According to an embodiment of the present invention, the content recording means may be further configured to record ancillary content as well. Ancillary content may include, but is not limited to, medical information (e.g., heart rate, breathing rate, body temperature, movement and blood pressure) and location. Location can be determined in numerous manners, such as through the use of global positioning systems (GPS) and other location based services (e.g., IP location, cellular triangulation). One of ordinary skill in the art would appreciate that there are numerous methods for determining the location of an apparatus, and embodiments of the present invention are contemplated for use with any method for determining the location of an apparatus. Further, one of ordinary skill in the art would appreciate that there are numerous forms of ancillary content that may be recorded by the content recording means, and embodiments of the present invention may be configured to utilize any form of ancillary content.

According to an embodiment of the present invention, a processing means of the apparatus is configured to process content data received from the content recording means. The processing means may be configured to perform analysis and conversion of the content into a format that is appropriate for transmittal and use on other computing devices (e.g., MP3, MP4, AVI, WAV, AAC). One of ordinary skill in the art would appreciate that there are numerous content formats that the processing means could convert raw content coming in from the content recording means into, and embodiments of the present invention are contemplated for use with any content format.

According to an embodiment of the present invention, the processing means may be further configured to provide the user the ability to interact with and set various preferences related to the recording of content. For instance, the processing means may provide the user the ability to set certain parameters for starting/stopping content recording/streaming. In this manner, the user may be provided methods for controlling the ways and times in which content is being recorded. Interaction with the apparatus may be via one or more interactive elements on the apparatus (e.g., buttons, touch sensors, audible sensors) or the control of the apparatus may be via one or more communications links (e.g., Bluetooth, Wi-Fi) connecting the apparatus to a remote computing device that provides command and control functions to the apparatus.

Other parameters or features that may be configured via the processing means, the interactive elements, the remote computing devices or any combination thereof, include, type of content to record (where more than one content recording means are available), where to stream/transmit content to (e.g., which social networking system) and under what conditions to start/stop recording (e.g., volume level, motion sensed). One of ordinary skill in the art would appreciate that there are numerous parameters and features that could be configured by way of these components, and embodiments of the present invention are contemplated for use with any parameter or feature.

In a preferred embodiment of the present invention, the wearable device will have an interactive element that will allow the starting and stopping or content recording under preconfigured settings that were determined when the wearable device was connected to a remote computing device via a connections link. For instance, a user may use a Bluetooth connection between the wearable device and a laptop to configure the wearable device to transmit content, via any wireless means available, to one or more particular social networking systems any time the user starts recording such content by depressing an interactive element on the wearable device.

According to an embodiment of the present invention, a communications means of the wearable device may be configured to allow command/control/configuration commands to be received and transmitted by the wearable device to one or more remote computing devices (as described above). The communication means may be further configured to transmit content to one or more remote computing devices, local storage means or to one or more social networking systems. In a preferred embodiment, the communications means may be configured to wirelessly transmit content to one or more social networking systems via one or more wireless transmission means (e.g., Wi-Fi, Bluetooth, CDMA, GSM, 3G, 4G). In this manner, the wearable device is capable of providing streaming or pre-recorded content to a social networking system in real-time or near real-time.

According to an embodiment of the present invention, a power source of the wearable device is configured to provide power to the various components of the apparatus. In a preferred embodiment, the power source may be a battery or other power storage means contained within the wearable device. In certain embodiments, the power source may be recharged by connecting the wearable device to a power charging source (e.g., mini-USB port, USB port, AC power adapter, DC power adapter) or by any wireless charging source (e.g., induction charger).

According to an embodiment of the present invention, the apparatus may be further comprised of a storage means (e.g., HDD, SSD, flash memory). The storage means may be configured to store content until such time as it can be consumed by or transmitted to one or more remote computing devices or social networking systems.

According to an embodiment of the present invention, the apparatus may be further comprised of one or more ports for providing external wired interaction with the apparatus. For instance, a mini-USB port may be provided to provide power and communications capabilities to the apparatus. In other embodiments a AC or DC power port may be provided for charging the power source of the apparatus. One of ordinary skill in the art would appreciate that there are numerous types of ports that could be utilized with embodiments of the present invention, and embodiments of the present invention are contemplated for use with any type of port.

In a preferred embodiment of the present invention, the apparatus is configured to be utilized as a component of a system that allows for streaming of content provided from the wearable device apparatus to the system which is comprised of one or more social networking systems configured to receive the content. In this manner, users may provide live streaming content to one or more social networking sites and other users may follow the content they are providing in a real time or near real time manner. For instance, if a first user with the wearable device apparatus is giving a speech at a conference, all those other users who follow or otherwise are connected to the first user via the social networking site may be able to consume the speech as if they were there and hear and/or see what is occurring at that specific time. This allows for the system described herein to provide a more realistic and real-time view of what the users are experiencing at that moment and gives a much more vivid social interaction than was previously possible.

Once the content has been streamed or otherwise provided to the social networking systems, the social networking systems can be configured to store the content on the social networking system for later consumption. In a preferred embodiment of the present invention, the content could be stored and made available to users based on one or more specific characteristics of the content (e.g., date of the recording of the content, location of the recording of the content, person(s) at the location where the content was recorded). One of ordinary skill in the art would appreciate that there are numerous manners in which the content could be related to one or more specific characteristics of the content, and embodiments of the present invention are contemplated for use with any such relationship.

In certain embodiments, the system may utilize or otherwise configure the social networking systems in such a manner that users providing content may limit access to such content by setting permissions on the content or their accounts. For instance, a user may be able to confirm other users prior to allowing access to content. In other embodiments, content may be made public by a user. In certain embodiments, a content providing user may also be provided the ability to block one or more other users from viewing or consuming the content. One of ordinary skill in the art would appreciate that there are numerous methods for providing/restricting access to content on social networking systems, and embodiments of the present invention are contemplated for use with any method for providing/restricting content.

### Exemplary Embodiments

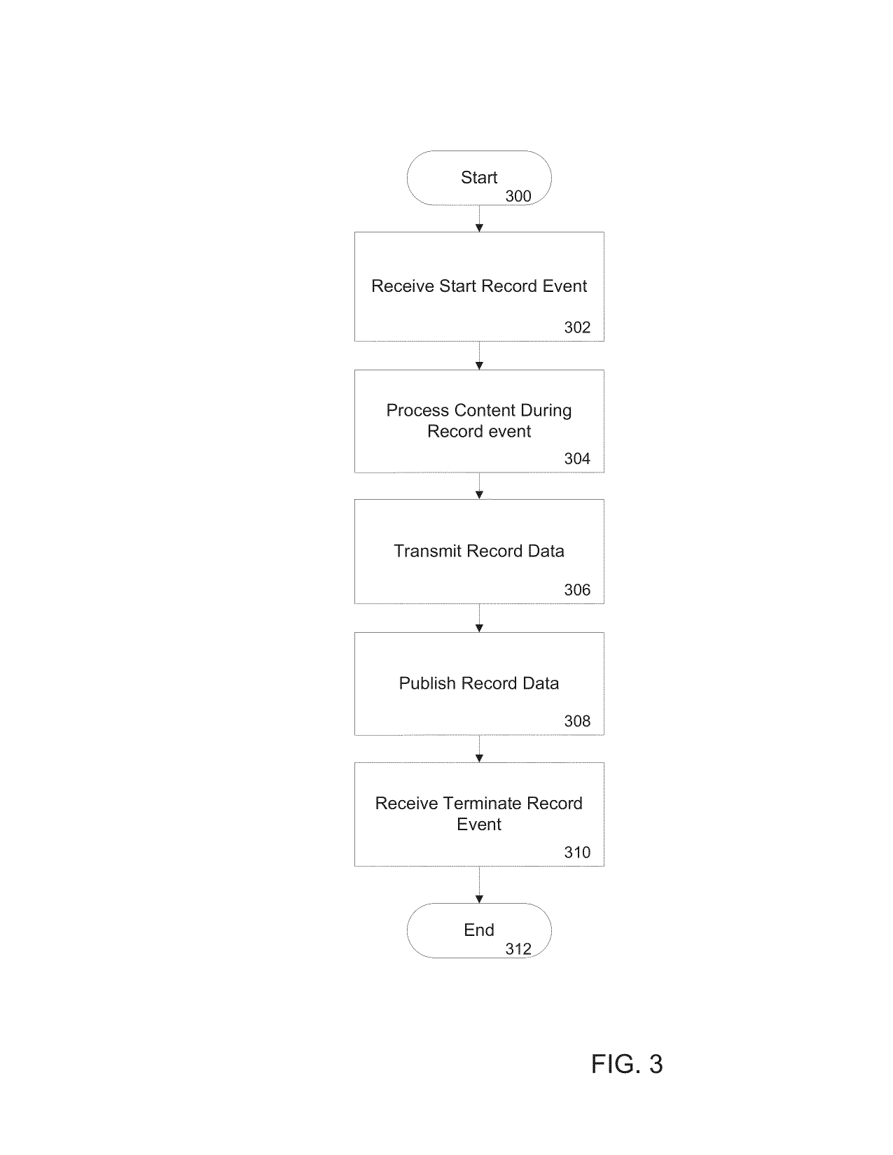

Turning now to FIG. 3, a flowchart of an exemplary method in accordance with an embodiment of the present invention is shown. At step 300, the process starts. At step 302, the wearable device receives a notification or event that requests the start of recording one or more types of content by the content recording means of the wearable device. The event and the type of content may be preconfigured as described previously in this application.

At step 304, the processing means begins to receive the raw content from the content recording means and begins to process the raw content into transmittable content that may be consumed by the remote computing devices or social networking systems the wearable device is configured to transmit the transmittable content to.

At step 306, the communications means begins to transmit the transmittable content to the appropriate destination (e.g., one or more remote computing devices, one or more social networking systems).

At step 308, the destination devices/systems publish the content in a manner consistent with their configuration. Certain devices/systems may be configured simply to store the content, while other devices/systems may be configured to provide streaming access to the content in a manner where other users can consume the content in real-time or near real-time.

At step 310, at some future point, the wearable device receives a notification or event to stop recording content. This notification or event is processed by the processing means and effects the cessation of the recording of new content. The process then terminates at step 312.

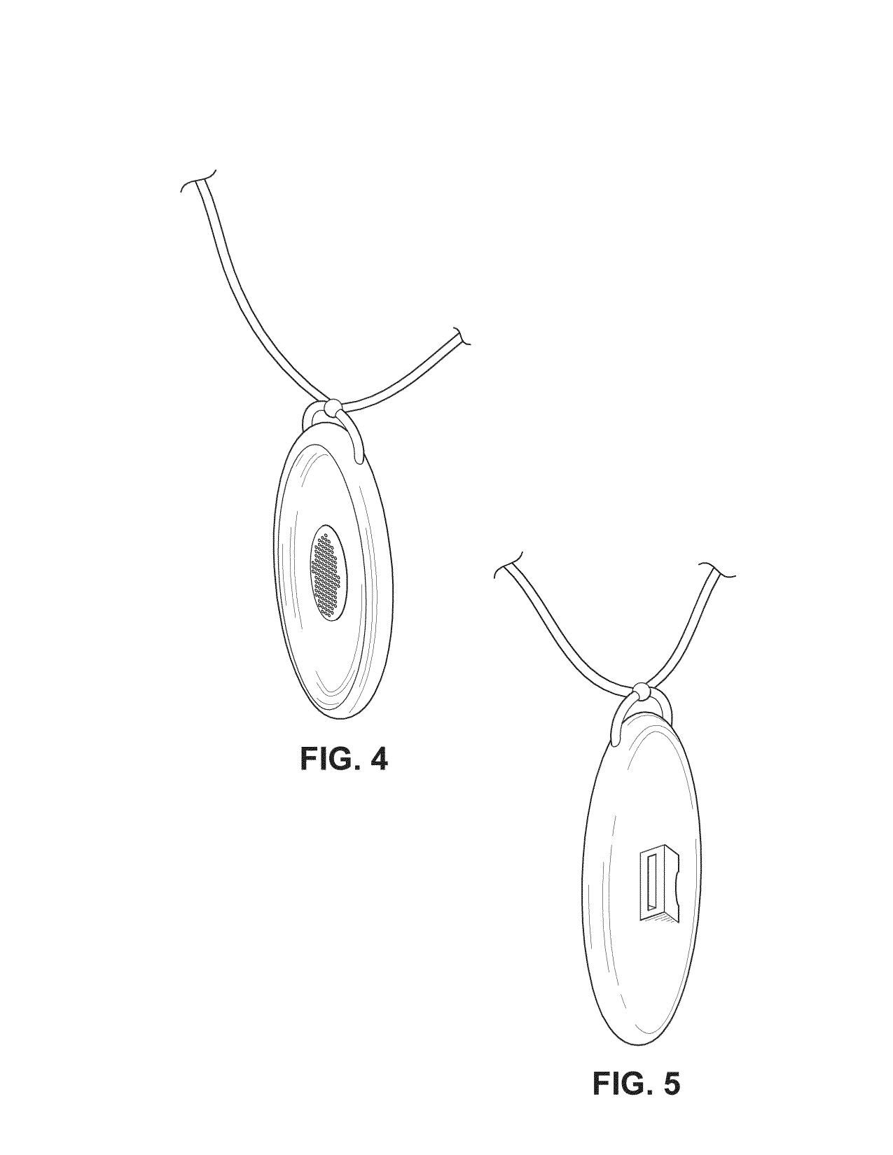

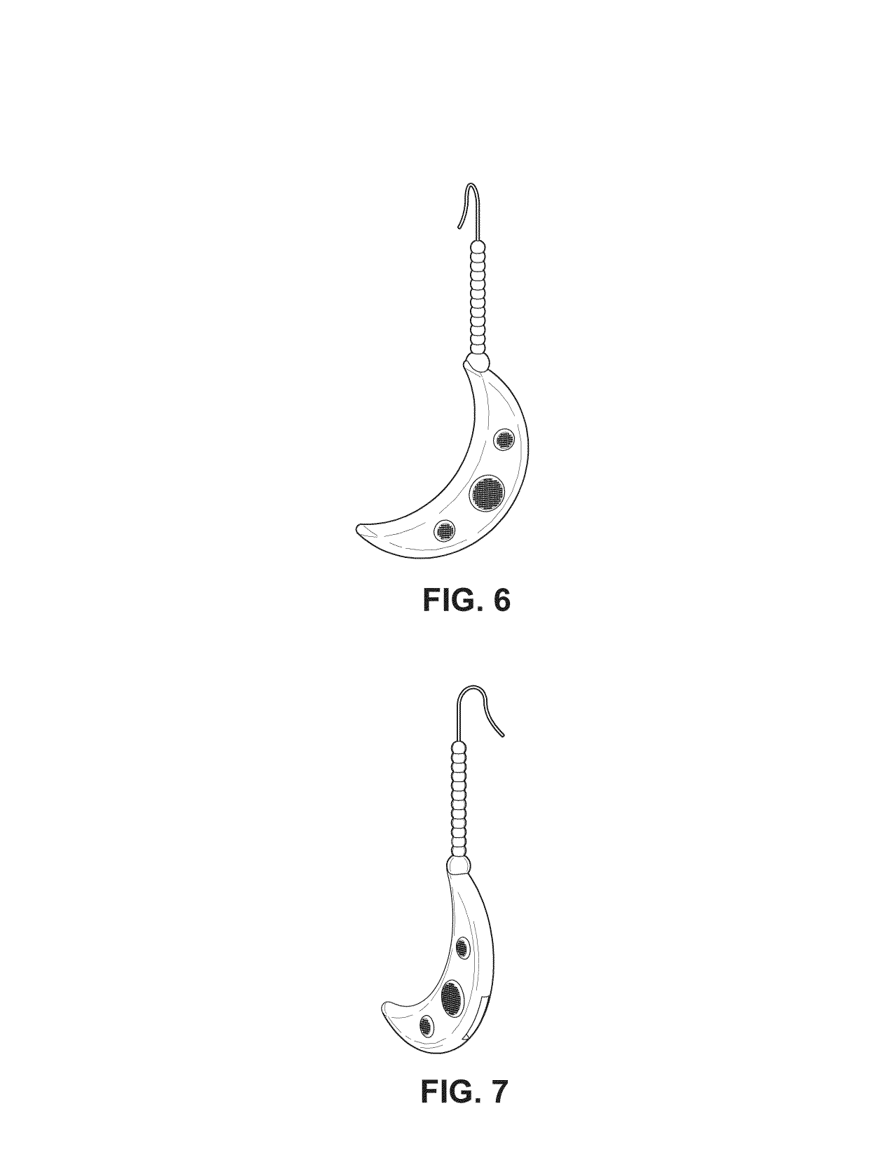

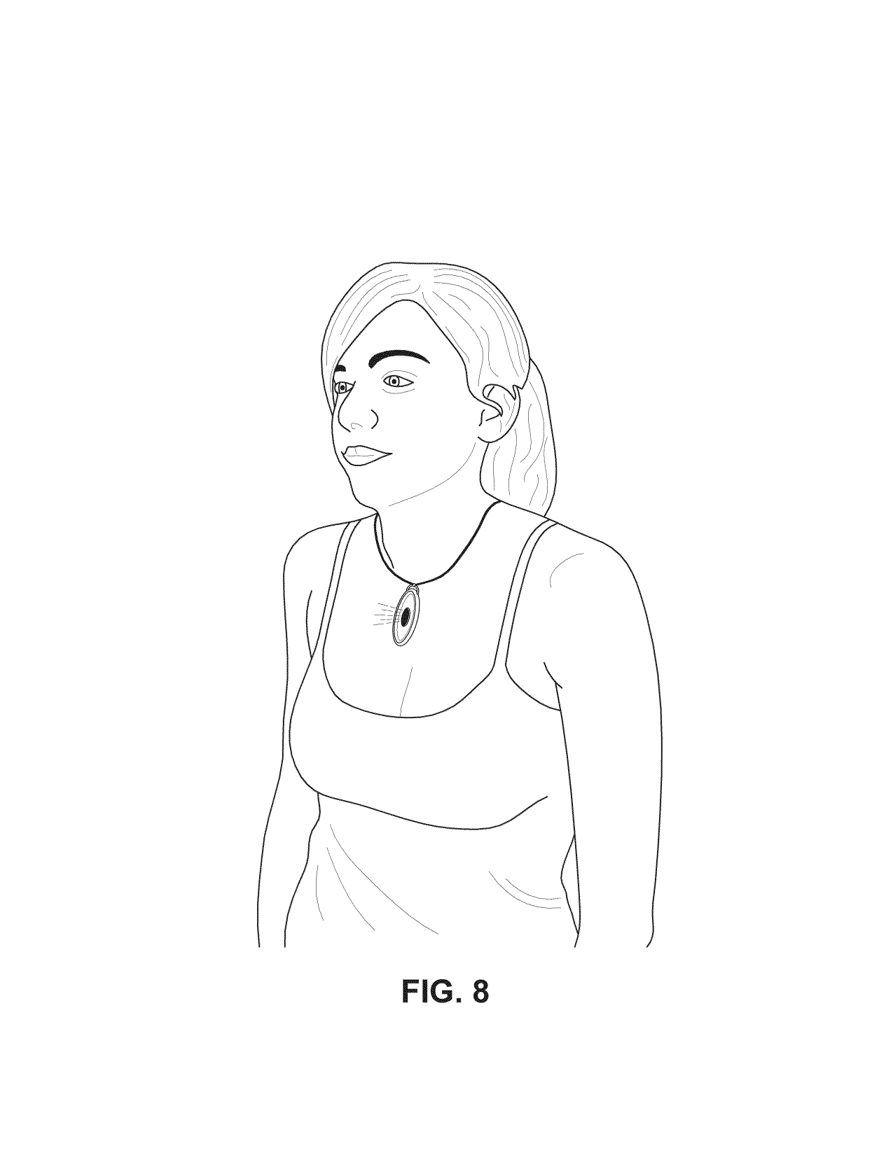

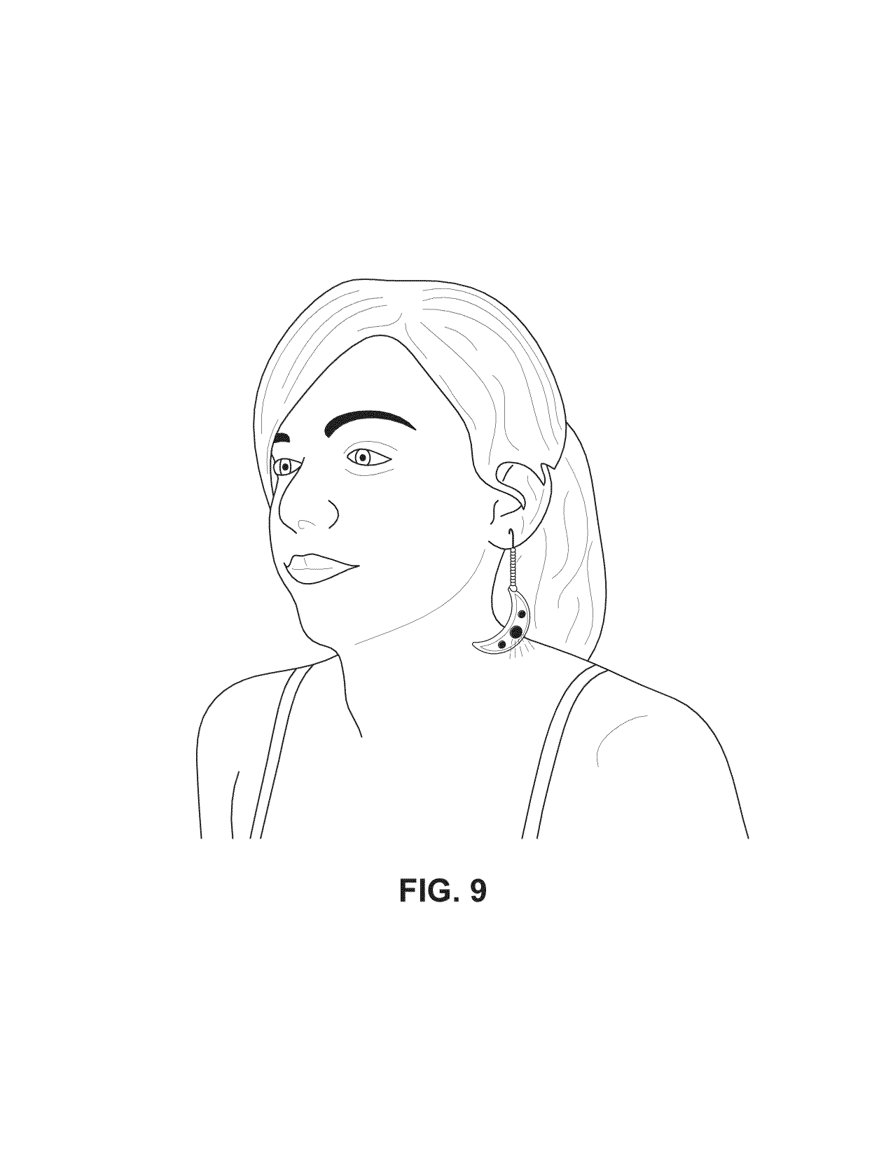

Turning now to FIGS. 4-9, various exemplary embodiments of the present invention are shown. FIGS. 4-5 and 8 shows a wearable device, as described herein, in the form of a necklace with a microphone 401 for recording audio content and a mini-USB port 402 for providing recharging of the power source and transfer of content via a wired means. FIGS. 6-7 and 9 shows a wearable device, as described herein, in the form of an earring with a microphone 601 for recording audio content.

One of ordinary skill in the art would appreciate that portions of the invention may be comprised of computer programs configured to instruct or control a computing device or other apparatus to perform one or more actions, such as those described herein.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. An apparatus for providing multimedia social streaming, the apparatus comprising:
a wearable housing comprising:
a content recording means;
a processing means;
a communications means; and
a power source,
wherein said content recording means is configured to receive one or more forms of content data,
wherein said processing means is configured to process said content data into transmittable content format data,
wherein said communications means is configured to transmit said transmittable content format data, and
wherein said power source is configured to provide operable power to one or more of said content recording means, processing means and communications means.

2. The apparatus of claim 1, wherein said wearable housing is an ornamental piece of jewelry.

3. The apparatus of claim 1, wherein said one or more forms of content data include one or more of audio data or video data.

4. The apparatus of claim 1, wherein said one or more forms of content data comprises live content.

5. The apparatus of claim 1, further comprising a storage means, wherein said communications means is configured to transmit said transmittable content format data to said storage means and said storage means is configured to store said transmittable content format data.

6. The apparatus of claim 1, further comprising one or more ports transposed through said wearable housing.

7. The apparatus of claim 6, wherein at least one of said one or more ports is configured to allow said power source to be attached to a recharging means.

8. The apparatus of claim 6, wherein at least one of said one or more ports is configured to allow said communications means to transmit said transmittable content format data to a computing device attached to said port.

9. The apparatus of claim 1, wherein said transmittable content format data is transmitted to a remote social network configured to allow one or more users to stream and consume said transmittable content format data.

10. A method for providing multimedia social streaming via a wearable apparatus, the method comprising the steps of:
receiving one or more forms of content data at a content recording means of said wearable apparatus;
processing said one or more forms of content data, at a processing means of said wearable apparatus, into transmittable content format data; and
transmitting said transmittable content format data, via a communications means of said wearable apparatus, to a remote social network.

11. The method of claim 10, wherein said wearable apparatus is an ornamental piece of jewelry.

12. The method of claim 10, wherein said one or more forms of content data include one or more of audio data or video data.

13. The method of claim 10, wherein said one or more forms of content data comprises live content.

14. The method of claim 10, further comprising the steps of:
receiving said transmittable content format data in a storage means of said wearable apparatus; and
storing, in said storage means, said transmittable content.

15. The method of claim 10, further comprising the step of:
receiving said transmittable content format data at a computing device attached to a port of said wearable apparatus.

16. The method of claim 10, wherein said transmittable content format data is transmitted to a remote social network configured to allow one or more users to stream and consume said transmittable content format data.
